(19) United States
(12) Patent Application Publication
(10) Pub. No.: US 2026/0087610 A1
(43) Pub. Date: Mar. 26, 2026

(54) Method and Device for Predicting Product Manufacturing Index

(71) Applicant: Wiwynn Corporation, New Taipei City (TW)

(72) Inventors: Ge-Wei Fang, New Taipei City (TW); Chih-Wei Chang, New Taipei City (TW)

(73) Assignee: Wiwynn Corporation, New Taipei City (TW)

(21) Appl. No.: 18/955,932

(22) Filed: Nov. 21, 2024

(30) Foreign Application Priority Data
Sep. 26, 2024 (TW) 113136694

(51) Int. Cl. G06T 7/00; G06V 10/25

(52) U.S. Cl. CPC G06T 7/0004; G06V 10/25; G06T 2207/20081; G06T 2207/30108

(57) ABSTRACT

A method for predicting product manufacturing index includes performing an image preprocessing on a flat development drawing of a product to convert the flat development drawing into input data; performing a principal component analysis (PCA) on the input data to convert the input data into a principal component data; and using a first artificial intelligence (AI) model to predict a manufacturing index of the product according to the principal component data.

### BACKGROUND OF THE INVENTION

### 1. Field of the Invention

The present invention relates to a prediction method and device, and more particularly, to a method and device for predicting a product manufacturing index based on a flat development drawing of a product by using artificial intelligence models.

### 2. Description of the Prior Art

Manufacturing of a product with a specific shape typically requires one or more molds to perform one or more shaping processes on the raw material. For example, producing a single mechanical component may involve various processes such as piercing, countersinking, blanking, riveting, lettering, bending, creasing, and coining. In practice, a single mold may be used to perform multiple processes, or several molds may be needed to complete the same process.

A cost of producing a product involves total numbers of processes and molds required, and relies on a supplier to provide a quotation based on a 3D drawing of the product. However, the quotation often vary from different suppliers or different evaluators, and the product designer can only count on his or her experiences to assess whether the quotation is reasonable. In addition, suppliers usually take three to five business days to provide quotation. Therefore, how to provide a method for predicting a product manufacturing index (i.e., the total number of processes or the total number of molds) is one of the most important issues in the field to facilitate cost estimation and shorten quotation time.

### SUMMARY OF THE INVENTION

Therefore, the present invention aims to provide a method and device for predicting product manufacturing index, so as to effectively evaluate the cost of molds and thereby serve as a reference for the design.

An embodiment of the present invention discloses a method for predicting product manufacturing index. The method includes performing an image preprocessing on a flat development drawing of a product to convert the flat development drawing into input data; performing a principal component analysis (PCA) on the input data to convert the input data into a principal component data; and using a first artificial intelligence (AI) model to predict a manufacturing index of the product according to the principal component data.

An embodiment of the present invention further discloses a first device for predicting product manufacturing index. The first device includes a first processing unit and a storing unit. The storing unit is coupled to the first processing unit and configured to store a program code. The program code instructs the first processing unit to perform the method for predicting product manufacturing index mentioned above.

An embodiment of the present invention further discloses a second device. The second device includes an image capturing unit and a communication unit. The image capturing unit is configured to capture a flat development drawing of a product. The communication unit, coupled to the image capturing unit, is configured to transmit the flat development drawing to the first device mentioned above and receive a manufacturing index of the product from the first device.

The method and devices of the present invention for using artificial intelligence models to predict a product manufacturing index on the basis of a flat development drawing of a product have the following features: (1) quickly analyzing the complexity of the development drawing to predict the product manufacturing index, which is advantageous: for cost estimation and shortening the quotation time; (2) providing the manufacturing index (i.e., the total number of processes or the total number of molds) to the designer as a kind of design reference for budget control; (3) training two artificial intelligence models and comparing the training results thereof to double verify the sample completeness of the training dataset; (4) judging whether there is still room for improvement in a performance of the first artificial intelligence model according to the performance of the second artificial intelligence model, so as to obtain the optimal model configuration of the first artificial intelligence model; and (5) in the prediction system, providing a prediction service from the service (the first device) to the client (the second device) in order to adapt to various application scenarios.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a first device for predicting product manufacturing index according to an embodiment of the present invention.

FIG. 2 is a schematic diagram of a prediction system according to an embodiment of the present invention.

FIG. 3 is a schematic diagram of a method for predicting product manufacturing index according to an embodiment of the present invention.

FIG. 4 is a flowchart of a product prediction process according to an embodiment of the present invention.

FIG. 5 is a flowchart of a preprocessing process according to an embodiment of the present invention.

FIG. 6A is an isometric view of a mechanical component according to an embodiment of the present invention.

FIG. 6B is a flat development drawing of the mechanical component in FIG. 6A according to an embodiment of the present invention.

FIG. 6C is a dimensionally normalized ROI according to an embodiment of the present invention.

FIG. 7 is a flowchart of a model training process according to an embodiment of the present invention.

FIG. 8 is a schematic diagram of the distribution of multiple support vectors in the feature space.

### DETAILED DESCRIPTION

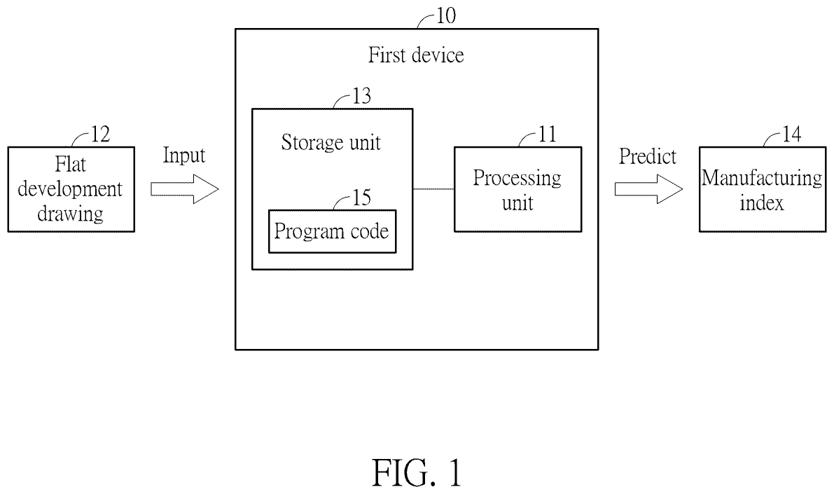

Please refer to FIG. 1, which is a schematic diagram of a first device 10 according to an embodiment of the present invention. The first device 10 is configured to predict a manufacturing index 14 using an artificial intelligence (AI) model based on a flat development drawing 12 of a product. The first device 10 may comprise a processing unit 11 and a storage unit 13. The storage unit 13 is coupled to the processing unit 11, and is configured to store a program code 15, where the program code 15 instructs the processing unit 11 to perform a method for predicting a product manufacturing index (hereinafter referred to as a “prediction method”). Since the manufacturing index 14 of a product is closely related to the complexity of the mechanical drawing, the present invention utilizes the AI model to analyze the complexity of the flat development drawing 12 and thus predict the corresponding manufacturing index 14.

It should be noted that, in addition to the manufacturing index 14, the manufacturing cost of the product is also related to its material and volume, and therefore a conversion function or mapping table needs to be constructed to estimate a closer-to-real manufacturing cost based on the manufacturing index 14. In a practical application, the first device 10 may run an engineering drawing software, such as AutoCAD, SolidWorks, CATIA, ProE, and the prediction method and conversion function may be compiled into a software tool and installed in a computer operating system or embedded in the engineering drawing software. Whenever a product design reaches a specific stage, the engineering drawing software may be used to export the flat development drawing 12, then the software tool may be used to predict the corresponding manufacturing index 14, and finally the conversion function may be used to estimate the manufacturing cost. As a result, the designer can compare the flat development drawings and manufacturing indices of multiple versions of the same product to select the most suitable version; in other words, the manufacturing index (i.e., total number of processes or total number of molds) may be used as a design reference for budget control.

In short, compared to traditional labor cost estimation, the first device 10 of the present invention is capable of quickly analyzing the complexity of the flat development drawing 12 to predict the manufacturing index 14, which is beneficial to cost estimation and shortens the quotation time. Furthermore, it also provides design references for budget control to designers.

The first device 10 may be and not limited to any kind of computers such as a centralized computing server, an edge computing server, an industrial computer, a desktop computer, a laptop computer, a tablet computer, and a smart phone. The processing unit 11 may be a general-purpose processor, a microprocessor, an application specific integrated circuit (ASIC), or a combination thereof, and is not limited thereto. The storage unit 13 may be any data storage device, such as a read-only memory (ROM), flash memory, random access memory (RAM), hard disk, optical data storage device, non-volatile storage unit, or combinations thereof, but is not limited thereto. In addition, the storage unit 13 is also used to store data for executing the method for predicting product manufacturing index, training datasets and testing datasets for the AI models, the flat development diagram 12, the manufacturing index 14, etc., and is not limited thereto. In other embodiments, the first device 10 further comprises at least one peripheral device, such as a display, a keyboard, a mouse, an image capturing unit, a communication unit, or a combination thereof, and is not limited thereto.

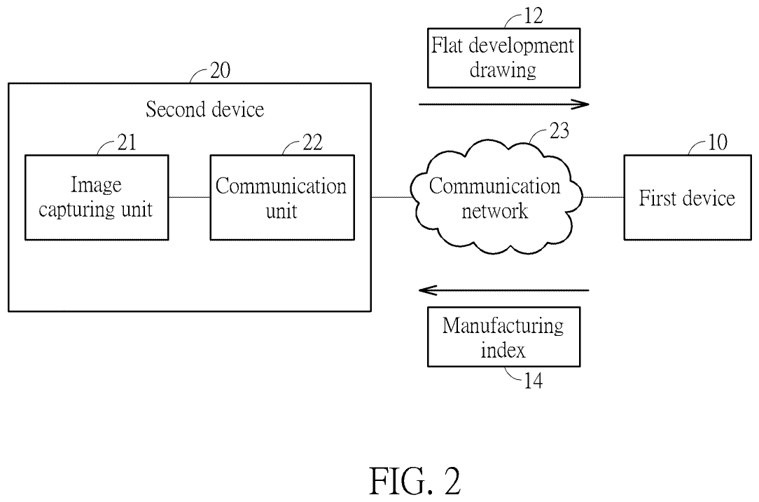

Please refer to FIG. 2, which is a schematic diagram of a prediction system according to an embodiment of the present invention. The prediction system comprises a first device 10, a second device 20, and a communication network 23. The second device 20 is linked to the first device 10 through the communication network 23 via wired or wireless means. The second device 20 comprises an image capturing unit 21 and a communication unit 22. The image capturing unit 21 is configured to obtain a flat development drawing 12 of a product. In other embodiments, the image capturing unit 21 is configured to obtain multiple perspective views of the product, and the second device 20 further comprises a processing unit coupled to the image capturing unit 21 and the communication unit 22. The processing unit is configured to stitch the multiple perspective views of the product into the flat development drawing 12. The communication unit 22 is coupled to the image capturing unit 21, and is configured to transmit the flat development drawing 12 of the product to the first device 10 and to receive the manufacturing index 14 of the product from the first device 10. In an embodiment, the communication unit 22 is configured to transmit the multiple perspective views of the product to the first device 10, and the first device 10 is configured to stitch the multiple perspective views of the product into the flat development drawing 12.

The second device 20 may be an electronic device such as a smartphone, tablet, laptop, desktop, wearable device, head-mounted virtual reality device, and is not limited thereto. The image capturing unit 21 may be a charge coupled device (CCD), camera, image sensor, etc., built-in or external to the second device 20, and is not limited thereto. The communication unit 22 may be a chip or network interface card that supports Wi-Fi, Ethernet, Bluetooth, mobile network or a combination thereof. The communication network 23 may be Internet, personal area network (PAN), local area network (LAN) or wide area network (WAN), and is not limited thereto.

It should be noted, in the prediction system, the second device 20 may be regarded as a client and the first device 10 may be regarded as a server, where the server is configured to provide prediction services to the client. In detail, the higher the complexity of the flat development drawing 12 becomes, the more the hardware resources are required to run the prediction method. Therefore, it is necessary for the server side (the first device 10) to provide the prediction service to the client (the second device 20) in order to adapt to various application scenarios. In an application scenario of tool manufacturing industry, a smartphone (the second device 20) may capture multiple perspective views of a tool to stitch the multiple perspective views into the flat development drawing 12, and transmit a service request with the flat development drawing 12 to an industrial computer (the first device 10) via the communication network 23. The industrial computer runs a prediction service in response to the service request, and then sends back the total number of molds (the manufacturing index 14) corresponding to the flat development drawing 12 to the smartphone. In an application scenario of interior design, a virtual reality headset (the second device 20) may scan walls, ceilings, and floors of an interior space to generate a panorama of interior design drawing (the flat development drawing 12), and transmit a service request with the panoramic to a cloud server (the first device 10) via the communication network 23. The cloud server runs a prediction service in response to the service request, and then sends back a total number of decorating processes (the manufacturing index 14) corresponding to the panorama to the virtual reality headset.

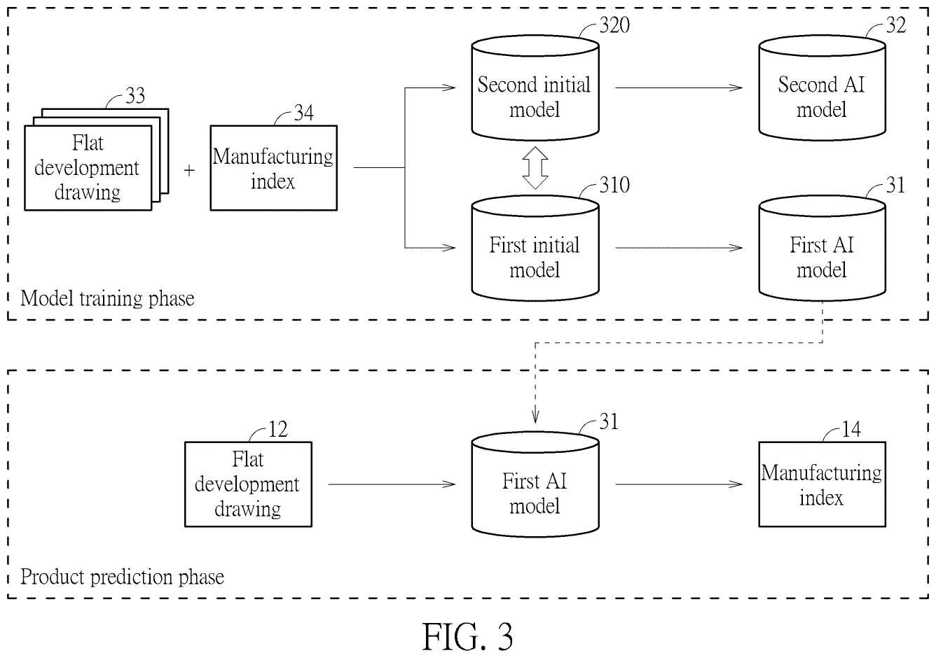

Please refer to FIG. 3, which is a schematic diagram of the method for predicting product manufacturing index according to an embodiment of the present invention. The prediction method comprises two phases: a model training phase and a product prediction phase. In the model training phase, the first device 10 trains a first initial model 310 corresponding to a first AI model 31 and a second initial model 320 corresponding to a second AI model 32 according to a plurality of flat development drawings 33 for training and the corresponding manufacturing index set 34. The first initial model 310 and the second initial model 320 are compared against each other for model optimization, so as to obtain the first AI model 31 used for predicting the product manufacturing index in the product prediction phase. In the product prediction phase, the first device 10 can utilize the trained first AI model 31 to predict the manufacturing index 14 based on the flat development drawing 12. In this embodiment, the first AI model 31 may be a support vector regression (SVR) model, and the second AI model 32 may be a linear regression model.

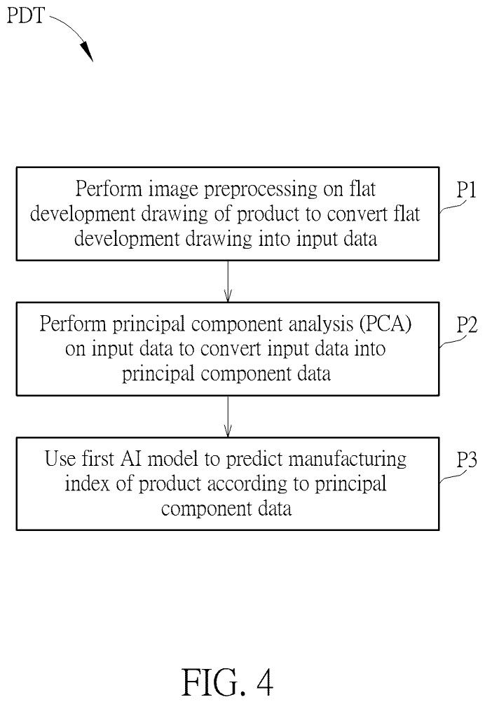

Please refer to FIG. 4, which is a flowchart of a product prediction process PDT according to an embodiment of the present invention. The product prediction process PDT may be compiled into the program code 15 to instruct the first device 10 to execute the method for predicting the manufacturing index of a product. The product prediction process PDT comprises the following steps:

Step P1: Perform an image preprocessing on a flat development drawing of a product to convert the flat development drawing into input data.

Step P2: Perform a principal component analysis (PCA) on the input data to convert the input data into a principal component data.

Step P3: Use a first AI model to predict a manufacturing index of the product according to the principal component data.

In Step P1, the first device 10 performs an image preprocessing on the flat development drawing 12 of a product to convert the flat development drawing 12 into input data. In Step P2, the first device 10 performs the principal component analysis to convert the input data into principal component data. Specifically, the principal component analysis is used to extract N principal components (i.e., key features) of a feature set of the input data and eliminate less influential features to reduce the dimensionality of the feature set of the input data. Accordingly, the principal component analysis can effectively reduce computation effort and improving the accuracy of AI models.

In Step P3, the first device 10 utilizes the first AI model 31 to predict the manufacturing index 14 for the product. Accordingly, by performing the product prediction process PDT, the first device 10 may realize the method for predicting the manufacturing index for the product. In some embodiments, the product may be a mechanical component, a printed circuit board, an interior space or a building, and the flat development drawing 12 may be a mechanical drawing, a printed circuit board layout, a panorama of interior design drawing or an architectural drawing. It should be noted, any object having a fixed shape (i.e., a product) and the corresponding engineering drawing (i.e., a flat development drawing) are within the scope of the present invention.

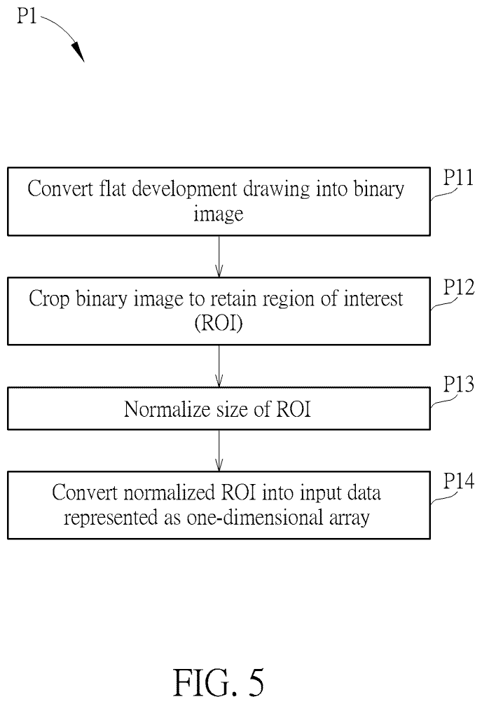

Please refer to FIG. 5, which is a flowchart of a sub-process of Step P1 in FIG. 4. Step P1 may be compiled into the program code 15 instructing the first device 10 to perform image preprocessing on each flat development drawing for converting the flat development drawing into one input data. Step P1 comprises the following steps:

Step P11: Convert the flat development drawing into a binary image.

Step P12: Crop the binary image to retain a region of interest (ROI).

Step P13: Normalize a size of the ROI.

Step P14: Convert the normalized ROI into the input data represented as a one-dimensional array.

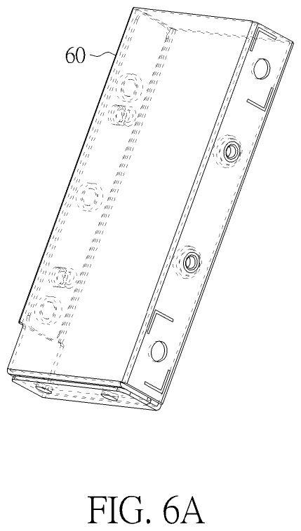

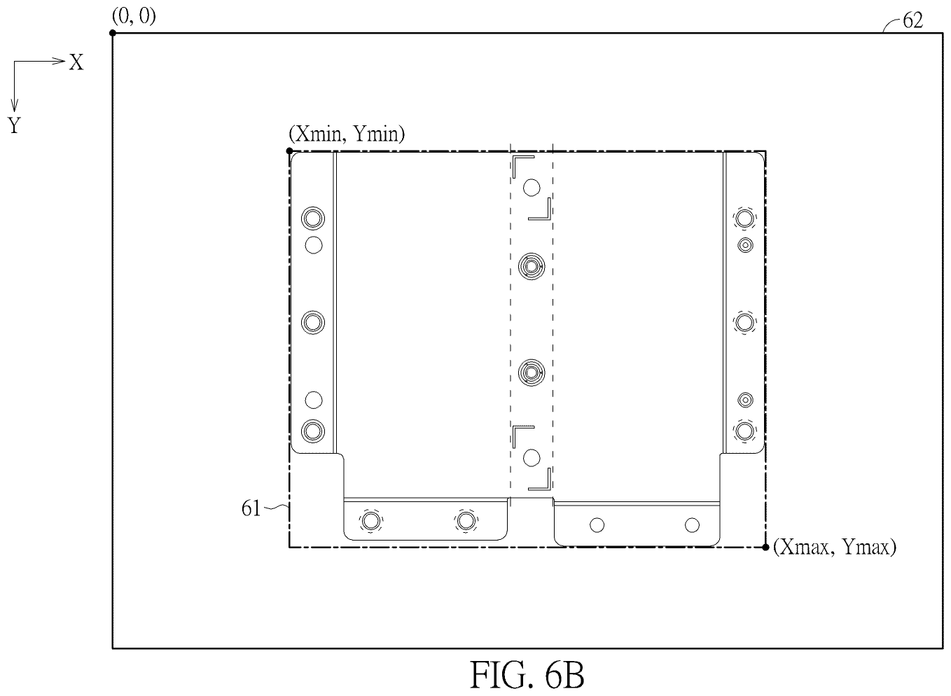

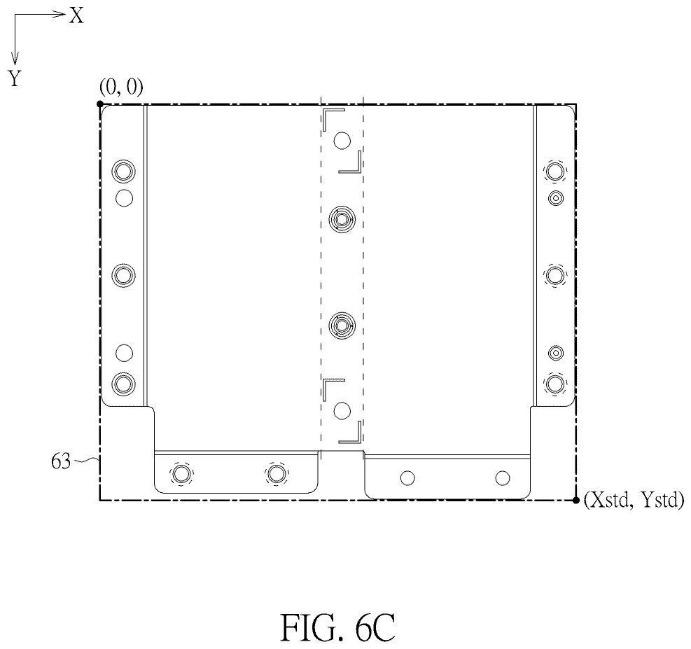

To illustrate the image preprocessing of Step P1, please refer to FIG. 6A, FIG. 6B, and FIG. 6C. FIG. 6A shows an isometric view of a mechanical component 60, FIG. 6B shows a flat development drawing 62 of the mechanical component 60, and FIG. 6C shows a dimensionally normalized ROI 63. As shown in FIG. 6A, the first device 10 may execute engineering drawing software to export the flat development drawing 62 of the mechanical component 60, or stitch together multiple perspective views of the mechanical component 60 to form the flat development drawing 62. According to the table below, manufacturing the mechanical component 60 needs 12 processes (a total number of processes is 12), and 6 molds (a total number of molds is 6). It should be noted that the manufacturing index 14 may be a total number of processes or a total number of molds. In this embodiment, the first device 10 uses the prediction method to predict the total number of molds of 6; however, in other embodiments, the prediction method may be used to predict the total number of processes.

| | Number of | Number of |
|---|---|---|
| Process Name | processes | molds |
| Embossing | 0 | 0 |
| Piercing | 2 | 1 |
| Countersinking | 1 | 1 |
| Blanking | 1 | 1 |
| Riveting | 1 | 0 |
| Drawing | 1 | 0 |
| Extruding | 0 | 0 |
| Bending | 2 | 2 |
| lettering/Creasing | 3 | 0 |
| Heming | 0 | 0 |
| Coining | 1 | 1 |
| Shaping | 0 | 0 |
| Total number | 12 | 6 |

As shown in FIG. 6B, it is assumed that the flat development drawing 62 is a grayscale image and each pixel has a grayscale value ranging from 0 to 255, where black has a grayscale value of 0 and white has a grayscale value of 255. In Step P11, the first device 10 converts the flat development drawing 62 into a binary image. In an embodiment, if the grayscale value of a pixel is not 255 (meaning that the pixel is not white), the first device 10 modifies the grayscale value of the pixel to 0 (meaning that the pixel that is not white is modified to black), so as to obtain a black and white image that has only grayscale values of 0 and 255. In another embodiment, the first device 10 modifies a grayscale value of the pixel to 0 if the grayscale value of the pixel is less than a predetermined threshold value, and modifies the grayscale value of the pixel to 255 if the grayscale value of the pixel is greater than or equal to the predetermined threshold value. In another embodiment, if the flat development drawing 62 is a color image, the first device 10 firstly converts the flat development drawing 62 to a grayscale image, and then performs binary conversion on the grayscale image to convert the grayscale image into the binary image. In an embodiment, the first device 10 may convert the flat development drawing into the grayscale image based on an average of the red, green, and blue color scales, and then convert the grayscale image to the binary image based on a predetermined threshold value.

In Step P12, the first device 10 crops the binary image to retain a region of interest (ROI) 61. In practice, there may be a blank area in the flat development drawing 62. In order to avoid the blank area from affecting the predicted results of the manufacturing index, the blank area needs to be cut off. Specifically, the first device 10 may perform contour detection on the binary image obtained in Step P11 and crop according to the contour to retain the ROI 61 containing the process information. In an embodiment, it is assumed that a coordinate of an origin of the flat development drawing 62 is (0, 0), during the process of converting the binary image, the first device 10 records a minimum value Xmin and a maximum value Xmax of non-white pixels on the X-axis, as well as a minimum value Ymin and a maximum value Ymax of non-white pixels on the Y-axis. And then, the first device 10 sets a minimum non-white coordinate of the flat development drawing 62 to (Xmin, Ymin) and a maximum non-white coordinate of flat development drawing 62 to (Xmax, Ymax) to define the ROI 61.

As shown in FIG. 6C, in Step P13, the first device 10 normalizes a size of the ROI so that all preprocessed images have uniform dimensions. In an embodiment, the first device 10 maps the minimum non-white coordinate (Xmin, Ymin) of the flat development drawing 62 to the origin coordinates (0, 0), maps the maximum non-white coordinate (Xmax, Ymax) to a terminal coordinates (Xstd, Ystd), and maps all coordinates of pixels of the flat development drawing 62 to the dimensionally normalized ROI 63.

In Step P14, the first device 10 converts the normalized ROI 63 into input data represented as a one-dimensional array. Specifically, the ROI 63 has been converted into a black and white image with gray scale values of only 0 and 255, and the first device 10 reads the gray scale value of each pixel in sequence from the origin coordinate (0, 0) to the terminal coordinate (Xstd, Ystd). If the gray scale value of a pixel is 0, a binary bit “1” is generated and stored in an array; if the gray scale value of a pixel is 255, a binary bit “0” is generated and stored in the array. As a result, the first device 10 generates input data represented as a one-dimensional array. In this way, the first device 10 can generate input data expressed as a one-dimensional array. Accordingly, the first device 10 may clean and format the flat development drawing 62 to convert the flat development drawing 62 into a form of data suitable for prediction and model training.

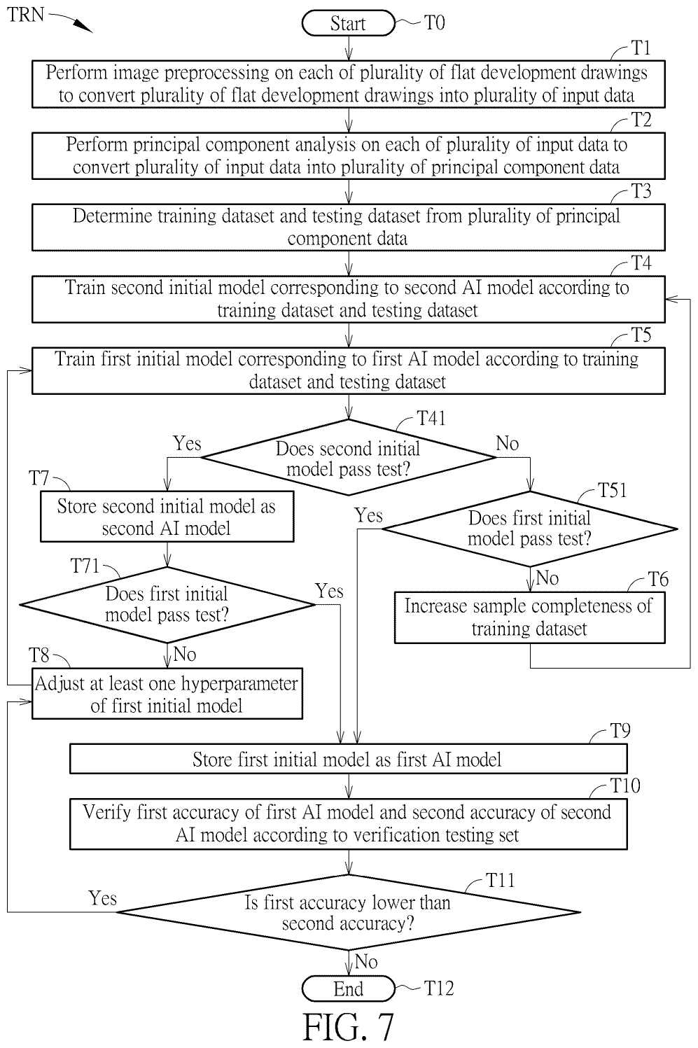

Please refer to FIG. 7, which is a flowchart of the model training process TRN according to an embodiment of the present invention. The model training process TRN may be compiled into the program code 15 instructing the first device 10 to train the first AI model 31. The model training process TRN comprises the following steps:
Step T0: Start.
Step T1: Perform image preprocessing on each of a plurality of flat development drawings to convert the plurality of flat development drawings into a plurality of input data.
Step T2: Perform principal component analysis on each of the plurality of input data to convert the plurality of input data into a plurality of principal component data.
Step T3: Determine a training dataset and a testing dataset from the plurality of principal component data.
Step T4: Train a second initial model corresponding to a second AI model according to the training dataset and the testing dataset.
Step T5: Train a first initial model corresponding to the first AI model according to the training dataset and the testing dataset.
Step T41: Determine whether the second initial model passes the test. If yes, proceed to Step T7; otherwise, proceed to Step T51.
Step T51: Determine whether the first initial model passes the test. If yes, proceed to Step T9; otherwise, proceed to Step T6.
Step T6: Increase sample completeness of the training dataset, and go back to Step T4.
Step T7: Store the second initial model as the second AI model.
Step T71: Determine whether the first initial model passes the test. If yes, proceed to Step T9; otherwise, proceed to Step T8.
Step T8: Adjust at least one hyperparameter of the first initial model, and then go back to Step T5.
Step T9: Store the first initial model as the first AI model.
Step T10: Verify a first accuracy of the first AI model and a second accuracy of the second AI model according to a verification testing set.
Step T11: Determine whether the first accuracy is lower than the second accuracy. If yes, proceed to Step T8; otherwise, proceed to Step T12.
Step T12: End.

In Step T1, the first device 10 performs image preprocessing on each of the plurality of flat development drawings 33 to convert the plurality of flat development drawings 33 into a plurality of input data. That is to say, the first device 10 cleans and formats collected data to ensure data quality and a prediction accuracy of the AI model. Reference of the preprocessing for the plurality of flat development drawings 33 is made in Step P1 of FIG. 5, so that the data for training and the data for prediction have the same data format. In an embodiment, it is assumed that there are n flat development drawings 33, the first device 10 stacks the n input data represented by a one-dimensional array to obtain the input data represented by an n-dimensional array, where n is a natural number.

In Step T2, the first device 10 performs a principal component analysis on each of the plurality of input data to convert the plurality of input data into a plurality of principal component data. The first device 10 retains N principal components by the principal component analysis method to reduce a feature dimension of the plurality of the input data, which effectively reduces computation overhead and improves the accuracy of the AI model.

In Step T3, the first device 10 determines a training dataset and a testing dataset from the plurality of principal component data. In an embodiment, the training dataset and the testing dataset may be determined by random sampling. In an embodiment, the training dataset and the testing dataset may be divided by K-fold cross-validation or leave-one-out cross-validation, but are not limited thereto. Once the training dataset and the testing dataset have been determined, the first device 10 may determine a training manufacturing index set corresponding to the training dataset from a total process number set 46 and a testing manufacturing index set corresponding to the testing dataset from the total process number set 46.

In Step T4, the first device 10 trains the second initial model 320 corresponding to the second AI model 32 according to the training dataset and the testing dataset. Specifically, the first device 10 firstly trains the second initial model 320 based on the training dataset and the training manufacturing index set corresponding to the training dataset. Then, the first device 10 tests the second initial model 320 according to the testing dataset and the testing manufacturing index set corresponding to the testing dataset.

In Step T5, the first device 10 trains the first initial model 310 corresponding to the first AI model 31 according to the training dataset and the testing dataset. Specifically, the first device 10 firstly trains the first initial model 310 according to the training dataset and the training manufacturing index set of Step T3. Next, the first device 10 tests the first initial model 310 according to the testing dataset and the testing manufacturing index set corresponding to the testing dataset. In Step T41, the first device 10 determines whether the second initial model 320 passes the test. In Steps T51 and T71, the first device 10 determines whether the first initial model 310 passes the test.

When both the first initial model 310 and the second initial model 320 do not pass the test, it means that samples of the training dataset used to train the model are not evenly distributed or have insufficient sample completeness. Therefore, in Step T6, the first device 10 increases the sample completeness of the training dataset, and then goes back to Step T4 to retrain the second initial model 320 and the first initial model 310. It should be noted, in the embodiments of the present invention, two AI models are trained to double verify the sample completeness of the training dataset. If the samples of the training dataset are randomly distributed or do not have a certain degree of linear relationship, training results of the two AI models will be very different, so it is necessary to add different samples to the training dataset to improve the sample completeness.

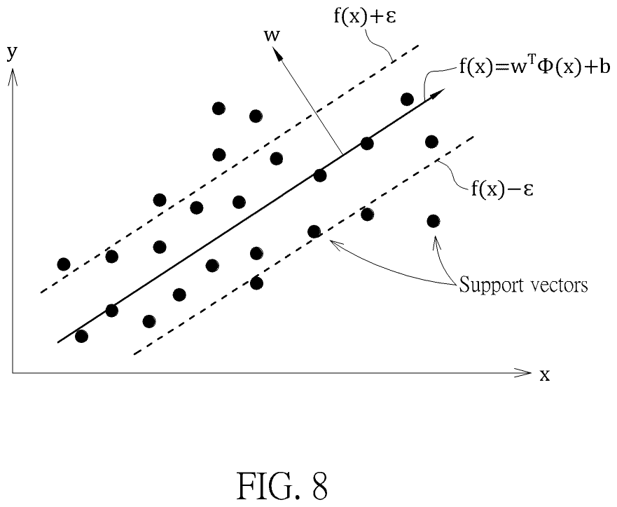

When the first initial model 310 does not pass the test and the second initial model 320 passes the test, the first device 10 adjusts at least one hyperparameter of the first initial model 310 in Step T8 and then returns to Step T5 to retrain the first initial model 310 based on the new hyperparameter. Specifically, please refer to FIG. 8, which is a schematic diagram of a distribution of multiple support vectors in a feature space. Support vector regression is a statistical machine learning method used to find a hyperplane in the feature space that accommodates multiple support vectors (i.e., input data or training samples), which may be represented by the following regression function ƒ(x):

$$f ( x ) = {w}^{T} Φ ( x ) + b$$

where x is the support vector corresponding to the input data, w^{T} is a coefficient vector of the feature space, Φ(x) is a kernel function, and bis an intercept. The kernel function Φ(x) is used to map the input data x to the feature space. A range of the regression function ƒ(x) is between a deviation ±ε. A goal of training the first initial model 310 is to find the best fitting configuration of the hyperplane, which requires solving the following objective function:

$${min}_{w} \frac{1}{2} {w}^{T} w + C {\sum }_{i = 1}^{n} {ζ}_{i}$$

where w is the coefficient vector of the feature space, C is a regularization parameter, ζᵢ is an i-th slack variable, and n is the number of input data (i.e., the number of the plurality of flat development drawings 33).

In an embodiment, the first device 10 confirms the best fitting configuration of the first initial model 310 by changing a type of the kernel function. In an embodiment, the first device 10 adjusts the regularization parameter C to avoid overfitting of the first initial model 310 and to improve generalization of the first initial model 310. In an embodiment, the first device 10 adjusts the slack variable (also known as penalty parameters) and the deviation ±ε to avoid overfitting the first initial model 310. Accordingly, the first device 10 may adjust at least one hyperparameter to optimize the first initial model 310 to improve the accuracy of the first initial model 310 in predicting product manufacturing indices.

In Step T7, when the second initial model 320 passes the test, the first device 10 stores the second initial model 320 as the second AI model 32. In Step T9, when the first initial model 310 passes the test, the first device 10 stores the first initial model 310 as the first AI model 31.

In Step T10, no matter the second initial model 320 passes the test or not, when the first initial model 310 passes the test, the first device 10 verifies a first accuracy of the first AI model 31 and a second accuracy of the second AI model 32, respectively according to a verification testing set.

In Step T11, the first device 10 determines whether the first accuracy is lower than the second accuracy. When the first accuracy of the first AI model 31 is lower than the second accuracy of the second AI model 32, it means that there is still room for improvement in a performance of the first AI model 31, and the first device 10 may adjust the first initial model 310 in Step T8 and retrain the first initial model 310 in Step T5. It should be noted, the embodiment of the present invention determines whether there is still room for improvement in the performance of the first AI model 31 on the basis of the performance of the second AI model 32, so that the optimal model configuration of the first AI model 31 may be obtained for accurately predicting the manufacturing index of the product. When the first accuracy is not lower than the second accuracy, it means that the first AI model 31 has been successfully trained, and the model training process TRN may be finished.

In summary, the method and devices of the present invention for using artificial intelligence models to predict a product manufacturing index on the basis of a flat development drawing of a product development drawing have the following features: (1) quickly analyzing the complexity of the development drawing to predict the product manufacturing index, which is advantageous for cost estimation and shortening the quotation time; (2) providing the manufacturing index (i.e., the total number of processes or the total number of molds) to the designer as a kind of design reference for budget control; (3) training two artificial intelligence models and comparing the training results thereof to double verify the sample completeness of the training dataset; (4) judging whether there is still room for improvement in the performance of the first artificial intelligence model according to the performance of the second artificial intelligence model, so as to obtain the optimal model configuration of the first artificial intelligence model; and (5) in the prediction system, providing a prediction service from the service (the first device) to the client (the second device) in order to adapt to various application scenarios.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for predicting product manufacturing index, comprising:
Step P1) performing an image preprocessing on a flat development drawing of a product to convert the flat development drawing into input data;
Step P2) performing a principal component analysis (PCA) on the input data to convert the input data into a principal component data; and
Step P3) using a first artificial intelligence (AI) model to predict a manufacturing index of the product according to the principal component data.

2. The method of claim 1, wherein the step P1) comprises:
Step P11) converting the flat development drawing into a binary image;
Step P12) cropping the binary image to retain a region of interest (ROI);
Step P13) normalizing a size of the ROI; and
Step P14) converting the normalized ROI into the input data represented as a one-dimensional array.

3. The method of claim 2, wherein the step P11) comprises:
converting the flat development drawing into a grayscale image; and
performing binary conversion on the grayscale image to convert the grayscale image into the binary image.

4. The method of claim 1, wherein the method comprises performing a model training process before executing the step P1), and the model training process comprises:
Step T1) performing the image preprocessing on each of a plurality of flat development drawings to convert the plurality of flat development drawings into a plurality of input data;
Step T2) performing the principal component analysis on each of the plurality of input data to convert the plurality of input data into a plurality of principal component data;
Step T3) determining a training dataset and a testing dataset from the plurality of principal component data;
Step T4) training a second initial model corresponding to a second AI model according to the training dataset and the testing dataset; and
Step T5) training a first initial model corresponding to the first AI model according to the training dataset and the testing dataset.

5. The method of claim 4, wherein the step T4) comprises:
training the second initial model according to the training dataset and a training manufacturing index set corresponding to the training dataset; and
testing the second initial model according to the testing dataset and a testing manufacturing index set corresponding to the testing dataset.

6. The method of claim 5, wherein the step T5) comprises:
training the first initial model according to the training dataset and the training manufacturing index set corresponding to the training dataset; and
testing the first initial model according to the testing dataset and the testing manufacturing index set corresponding to the testing dataset.

7. The method of claim 6, wherein the model training process further comprises:
Step T6) when the first initial model and the second initial model do not pass the test, increasing sample completeness of the training dataset; and
returning to the step T4).

8. The method of claim 6, wherein the model training process further comprises:
Step T7) when the second initial model passes the test, storing the second initial model as the second AI model; and
Step T8) when the first initial model does not pass the test and the second initial model passes the test, adjusting at least one hyperparameter of the first initial model and returning to the step T5).

9. The method of claim 8, wherein the model training process further comprises:
Step T9) when the first initial model passes the test, storing the first initial model as the first AI model; and
Step T10) when the first initial model passes the test and no matter the second initial model passes the test or not, verifying a first accuracy of the first AI model and a second accuracy of the second AI model according to a verification testing set.

10. The method of claim 9, wherein the model training process further comprises:
Step T11) when the first accuracy is lower than the second accuracy, returning to the step T8); or
Step T11) when the first accuracy is not lower than the second accuracy, finishing the model training process.

11. The method of claim 4, wherein the second AI model is a linear regression model.

12. The method of claim 1, wherein the first AI model is a support vector regression (SVR) model.

13. The method of claim 1, wherein the product is a mechanical component, a printed circuit board, an interior space or a building, and the flat development drawing is a mechanical drawing, a printed circuit board layout, a panorama of interior design drawing or an architectural drawing.

14. The method of claim 1, further comprising stitching multiple perspective views of the product into the flat development drawing before the step P1).

15. The method of claim 1, wherein the manufacturing index is a total number of processes or a total number of molds.

16. A first device for predicting product manufacturing index, comprising:
a first processing unit; and
a storing unit, coupled to the first processing unit, configured to store a program code, wherein the program code instructs the first processing unit to perform the method of claim 1.

17. A second device, comprising:
an image capturing unit configured to capture a flat development drawing of a product; and
a communication unit coupled to the image capturing unit, configured to transmit the flat development drawing to the first device of claim 16, and receive a manufacturing index of the product from the first device.

18. The second device of claim 17, further comprising:
a second processing unit coupled to the image capturing unit and the communication unit, and configured to stitch multiple perspective views of the product into the flat development drawing;
wherein the image capturing unit is configured to obtain the multiple perspective views of the product.
